(19) United States
(12) Patent Application Publication
(10) Pub. No.: US 2006/0012338 A1
(43) Pub. Date: Jan. 19, 2006

(54) Charging device for charging a battery and method for the operation thereof

(76) Inventor: Peter Etzold, Ebersbach (DE)

Correspondence Address: Striker Striker & Stenby, 103 East Neck Road, Huntington, NY, 11743, US

(21) Appl. No.: 10/531,516

(22) PCT Filed: Sep. 9, 2004
(86) PCT No.: PCT/DE04/02031

§ 371 Date: Apr. 15, 2005

(30) Foreign Application Priority Data
Sep. 12, 2003 (DE) 103 42 129.7

(51) Int. Cl. H02J 7/00

(52) U.S. Cl. 320/125

(57) ABSTRACT

The invention relates to a charger for charging a battery and to a method for its operation. From the prior art, chargers with a charge-receiving mode for maintaining the battery voltage in a charged battery are known. The charge-receiving mode is characterized by two cyclically successive phases, a resting phase and a refreshing phase. During the resting phase, the battery discharges from an upper threshold voltage (U_{OG}) to a lower threshold voltage (U_{UG}). During the refreshing phase (A), the battery is charged again via a charge transformer (120) of the charger (100) from the lower to the upper threshold voltage. To minimize the power loss of the charger, it is proposed according to the invention that the charge transformer (120) in particular be switched off from the line voltage during the resting phase (R).

### PRIOR ART

The invention relates to a method for operating a line-voltage-fed charger for a battery, to a computer program, and to a charger for performing this method, as well as to a data medium having the computer program.

Such methods and chargers are fundamentally known in the prior art, for instance in the form of the battery charger LW 20/30 E made by Robert Bosch GmbH. The known charger is connected to the line voltage and serves to charge a battery, in particular a car battery. It includes a charge transformer for transforming the line voltage on the primary side into a secondary voltage, and a rectifier, downstream of the charge transformer on its secondary side, for furnishing a charging voltage for the battery. The key element in the known charger is a control unit for triggering the rectifier via a control signal in response to the charging voltage. The control unit is embodied not only for charging the battery when it is empty but also for keeping in its charged state and in this way counteracting its own self-discharging. This is done in a so-called charge-receiving mode. This charge-receiving mode includes a cyclical succession of a resting phase and a charging phase. In the resting phase, the battery discharges, particularly because of its self-discharging, from a predetermined upper threshold voltage to a lower threshold voltage that is lower than the upper threshold voltage, but preferably greater than the rated voltage of the battery. Once this lower threshold voltage is reached, the resting phase is ended within the charge-receiving mode, and the control unit is embodied to alternate from the resting phase to a refreshing phase. Within the refreshing phase, the battery is charged again via the charge transformer of the charger from the lower to the upper threshold voltage. The refreshing phase is substantially shorter chronologically than the resting phase.

This known charger has the disadvantage that even during the charge holding phase and particularly during the long-lasting resting phase, it has high current consumption and thus a high power loss. This high power loss is explained by the fact that even during the resting phase, that is, when no charging current is flowing, the charge transformer in particular nevertheless exhibits high current consumption for achieving remagnetizations.

With this prior art as the point of departure, it is therefore the object of the invention to embody a charger for charging a battery, a method for its operation, a computer program for performing this method, and a data medium having this computer program, in such a way that the power loss of the charger while it is in a charge-receiving mode is minimized.

This object is attained by the method claimed in claim 1. For the method described at the outset, that is, the described cyclical alternation between a resting phase and a refreshing phase within a charge-receiving mode, the object is attained by providing that at least individual components and in particular the charge transformer of the charger are switched off from the line voltage during the resting phase.

### ADVANTAGES OF THE INVENTION

Proceeding in this way offers the advantage that during the resting phases, that is, when the battery is fully charged and no refreshing charging operations take place, particularly the charge transformer does not draw current to furnish a charging current. Moreover, the claimed shutoff also assures that the charge transformer does not draw current for other purposes, particularly for remagnetization purposes, during the resting phase. In this way, the power loss of the charge transformer during the resting phase is lowered to a value of 0 W. The shutoff of the charge transformer and the supply transformer from the line voltage furthermore offers the advantage that simultaneously all the other components of the charger that are supplied from the secondary side of the supply transformer are also simultaneously switched off from the line voltage and thus made loss-free.

The aforementioned object of the invention is furthermore attained by a computer program and a charger for performing the claimed method and by a data medium having the computer program. The advantages of these embodiments are essentially equivalent to those named above with reference to the claimed method. Furthermore, additional advantages can be attained by various versions of the charger in the form of various exemplary embodiments. Various exemplary embodiments of the method and of the charger are the subject of the dependent claims.

### DRAWINGS

A total of three drawings are appended to the description, and in them

FIG. 1 shows a first exemplary embodiment for the charger of the invention;

FIG. 2a shows the course of the battery voltage during a charging mode and a charge-receiving mode;

FIG. 2b shows one example for the course of a charging current during the modes of FIG. 2a;

FIG. 2c shows the activation and deactivation behavior of a switching device in the charger of the invention; and

FIG. 3 shows a second exemplary embodiment for the charger of the invention.

### DESCRIPTION OF THE EXEMPLARY EMBODIMENTS

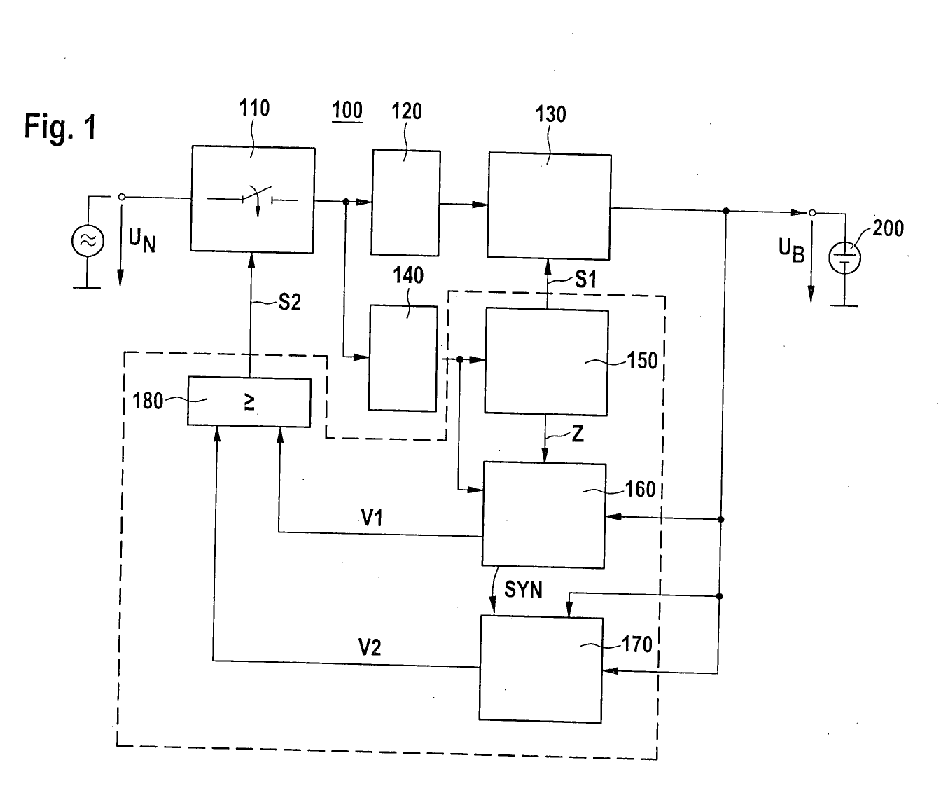

The invention will be described in detail below in the form of exemplary embodiments, with reference to FIGS. 1 through 3.

FIG. 1 shows a first exemplary embodiment for the charger 100 of the invention. It is connected to a line voltage U_{N} and serves to charge a battery 200. It includes a switching device 110, controlled by a switching signal S2, for applying the line voltage U_{N} to a charge transformer 120 and a supply transformer 140 connected parallel on the primary side to the charge transformer 120. Downstream of the charge transformer 120, which serves essentially to furnish the requisite charging current for charging the battery 200, is a rectifier 130 for furnishing a charging voltage U_{B} for the battery 200. The supply transformer 140 serves to furnish a supply voltage for a control unit 150 and a first comparator 160. The control unit 150 controls the rectifier 130, via a control signal S1. Via a status signal Z, the control unit 150 informs the first comparator 160 of the operating mode, such as the charge-receiving mode, in which the charger is currently being operated. The first comparator 160 compares the charging voltage U_{B,} which when the battery is connected is equivalent to the battery voltage, with a predetermined upper threshold voltage and generates a first comparison signal V1, if the battery voltage has reached or exceeded this upper threshold voltage U_{OG}.

Besides the first comparator 160, the charger 100 also includes a second comparator 170. This second comparator, in the first exemplary embodiment, unlike the first comparator 160 is supplied not by the supply transformer 140 but rather from the battery voltage U_{B}. The battery voltage U_{B} simultaneously serves as an input variable. The second comparator 170 compares the battery voltage with a predetermined lower threshold voltage U_{UG} and generates a second comparison signal V2, if the battery voltage has reached or undershot the lower threshold voltage U_{UG}. For forming the aforementioned switching signal S2 for triggering the switching device 110, the first and second comparison signals V1, V2 are OR-linked with one another in an OR logic module 180.

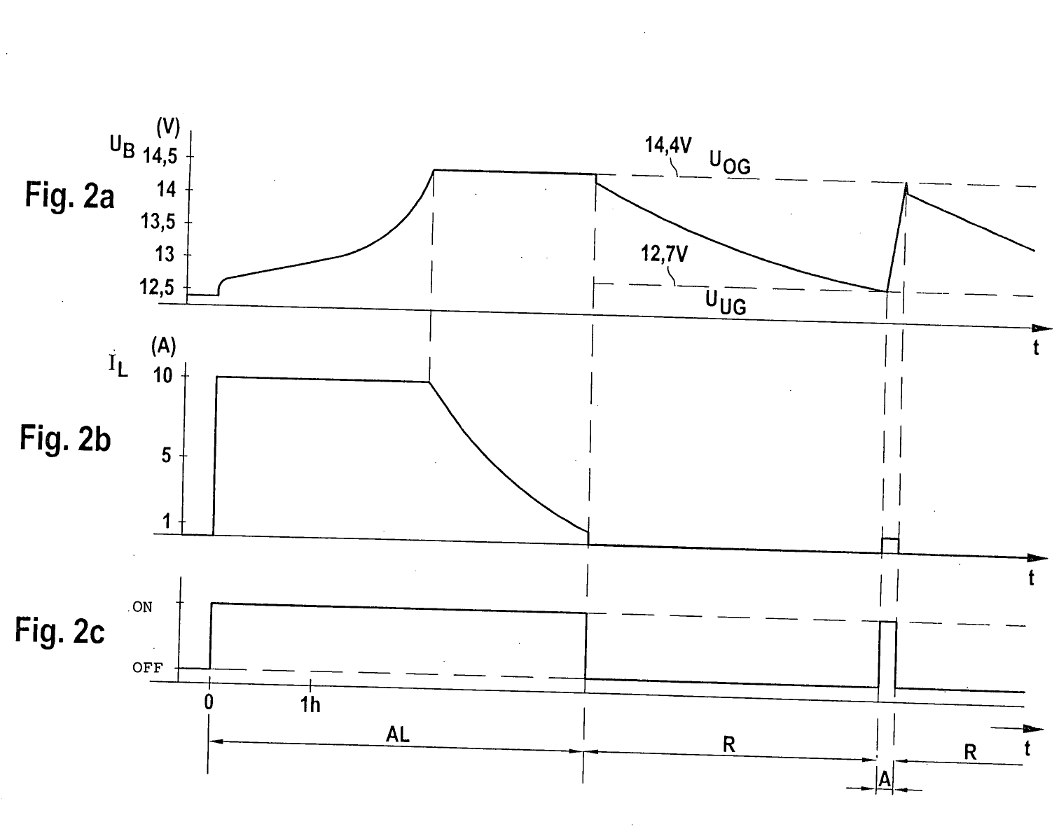

With the aid of FIGS. 2a, 2b and 2c, the mode of operation of the charger shown in FIG. 1 will now be explained. The charger 100 serves first to charge the battery 200. To that end, the control unit 150 puts the charger 100 in a so-called charging mode AL. This charging mode comprises two successive phases. The first phase can be seen in FIG. 2b from the fact that during this first phase the battery is charged with a constant current. Because of this charging with a constant current, the battery voltage initially increases only slowly, but over the course of time increasingly rapidly up to the level of the upper threshold voltage U_{OG}. Once this upper threshold voltage U_{OG} is reached, the first phase ends, and the second phase of the charging mode AL is initiated. During this second phase, the battery is supplied with a constant charging voltage, which is equivalent to the upper threshold voltage; see FIG. 2a. This second phase of the charging mode AL ends whenever the charging current has dropped to a predefined threshold current which is substantially less than the constant current during phase 1. During the entire charging mode AL, that is, during both its first and its second phase, the switching device 110 is switched on.

When both these criteria are present, that is, U_{B}=U_{OG} and the charging current is less than or equal to the threshold current, the control unit 150 directs the charger from the charging mode AL to a so-called charge-receiving mode. This mode is characterized by a sawtooth course of the battery voltage, as shown in FIG. 2a. It can be broken down into two cyclically successive phases, that is, a resting phase R and a refreshing phase A. After the charging mode, the charger first changes over, within the charge-receiving mode, to the resting phase R. During this resting phase, the battery is no longer supplied with a charging current IL, as shown in FIG. 2b; its voltage drops from the upper threshold voltage U_{OG} to the lower threshold voltage U_{UG}. It must be remembered that the battery, after the conclusion of the charging mode or in other words during the charge-receiving mode, is fully charged. The lower threshold voltage U_{UG}, while considerably below the upper threshold voltage U_{OG}, is still preferably above the rated voltage of the battery 200. The values given in FIG. 2a for the battery voltage U_{B} pertain to a battery 200 with a rated voltage of 12 V. According to the invention, the switching device 110 is switched off during the resting phase R by the switching signal S2, or more precisely by the comparison signal V1, or in other words is opened; see FIG. 2c. Thus in the first exemplary embodiment of the charger shown in FIG. 1, the charge transformer 120 and the supply transformer 140 are likewise decoupled from the line voltage on their primary side. Their current consumption and hence their power loss are in this way made to be zero during the resting phase R. This is true particularly because in this way they are also prevented from drawing a current for remagnetization purposes.

As soon as the second comparator 170 has ascertained that the battery voltage U_{B,} particularly from self-discharging of the battery, has dropped to a value of the predetermined lower threshold voltage U_{UG}, it generates the second comparison signal V2 and thus, regardless of the state of the first comparison signal V1, switches the switching device 110 back on again via the OR logic module 180. On being switched on, that is, upon the application of the line voltage to the charge transformer and to the supply transformer, the charger is again put in a position to perform a charging operation. However, in this situation during the charge-receiving mode, since the battery 200 is still charged, but its battery voltage has merely dropped to the lower threshold voltage U_{UG}, a brief refreshing of the battery 200 suffices to raise its battery voltage U_{B} back to the upper threshold value U_{OG}. To that end, the charger briefly changes over to a refreshing phase A, during which, as noted, the line voltage is again applied to the charger, and the battery is charged via a slight charging current, which is substantially less than the constant charging current during the first phase of the charging mode. The end of this refreshing phase A is recognized and initiated by the first comparator 160 when the comparator detects that the battery voltage has again reached the upper threshold voltage U_{OG} after previously, during the preceding resting phase, having dropped to the lower threshold voltage U_{UG}. To make this finding, the first comparator 160 assesses not only the battery voltage U_{B} but also a status signal Z, which is delivered to it by the control unit 150 and contains information about the current operating mode of the charger, and in particular about the presence of a current refreshing phase.

After the end of a refreshing phase A, the charger changes back again to a succeeding resting phase. According to the invention, the line voltage is switched off again via the switching device 110, in order as noted to minimize the ohmic losses during this time. However, so that the first comparison signal, via the OR logic module 180 and the switching signal S2, can be at all capable of switching off the switching device 110, it is necessary that the second comparison signal V2 also be put in a suitable state. According to the invention, this is attained by synchronizing the two comparison signals with one another in this situation, that is, at the transition from a refreshing phase to a resting phase.

In the first exemplary embodiment shown in FIG. 1, the charge transformer 120, the rectifier 130, the supply transformer 140, the control unit 150, and the first comparator 160 are connected to the line voltage and are supplied by it. This has the advantage that upon shutoff of the line voltage, for instance during a resting phase, they do not generate any power loss. However, this is not true for the second comparator 170, because in the first exemplary embodiment it is supplied via the battery voltage. This is disadvantageous in the sense that the second comparator 170 puts a load on the charged battery, even during the charge-receiving mode in particular, and thus unfavorably contributes to discharging the battery that is supposed to be getting charged at the time.

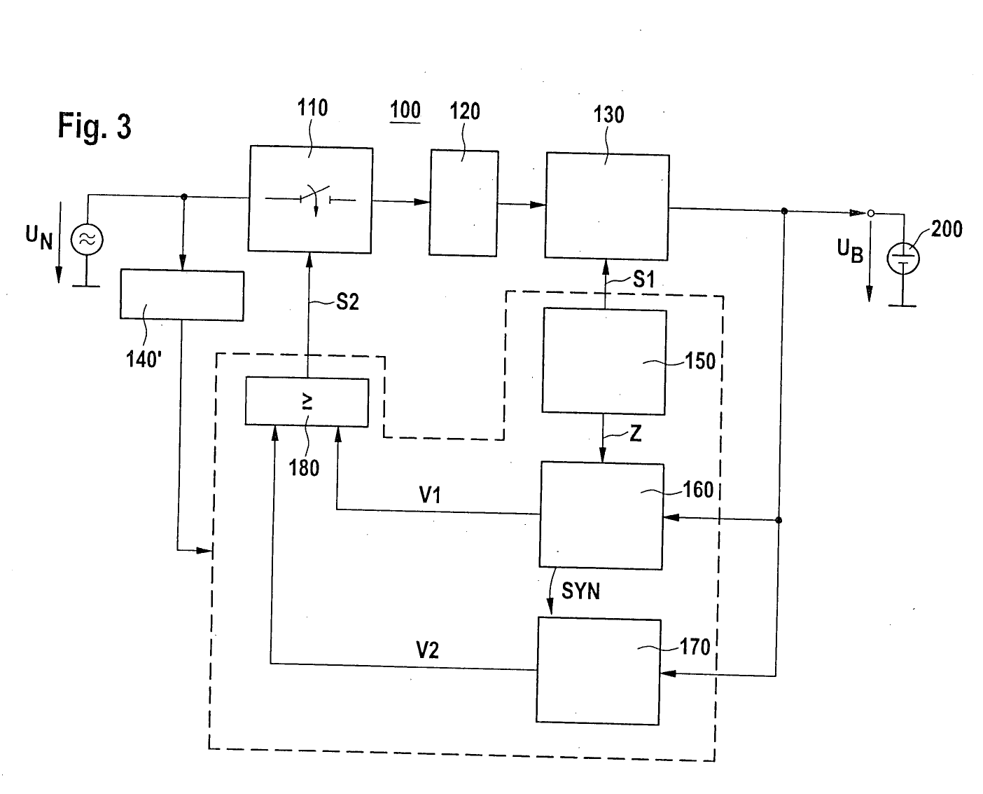

This disadvantage is circumvented with the second exemplary embodiment of the charger, shown in FIG. 3. Unlike the first exemplary embodiment shown in FIG. 1, in the second exemplary embodiment the control unit 150, the first and second comparators 160, 170, and the OR logic module 180 are supplied with a voltage via a supply transformer 140′; the supply transformer 140′, unlike the supply transformer 140, cannot be shut off, or in other words is connected permanently to the line voltage U_{N}. Thus not only is there not the disadvantage that the battery is loaded by the second comparator and in particular even during the charge-receiving mode, but there is only an improved capability, via the control unit, of triggering displays or light-emitting diodes, since in the second exemplary embodiment a continuous voltage supply is assured. The second exemplary embodiment shown in FIG. 3 does offer the advantage over the first exemplary embodiment shown in FIG. 1 that none of the components of the charger load the battery, but it also has the disadvantage that the control unit 150, the first and second comparators 160, 270, and the OR logic module 180 are supplied continuously with a supply voltage, that is, particularly even during the charge-receiving mode and particularly during the resting phase, via the supply transformer and therefore generate a power loss. The power loss of these components of the charger, which are included inside the outline shown in dashed lines in FIG. 3, is considerably less, however, than the power loss generated during an identical unit of time by the charge transformer 120. In this respect, this second exemplary embodiment of the charger 100 is entirely advantageously usable in practice.

For exemplary embodiments, the following is true: The switching device 110 is embodied preferably as an opto-triac. Individual components of the charger 100, and in particular the components outlined by dashed lines in FIGS. 1 and 3, are preferably embodied as an integrated circuit, for instance in the form of a microcontroller, with a suitable computer program. However, the comparators 160 and 170 in particular may also be embodied in hardware form as analog circuits.

1. A method for operating a line-supplied charger (100) for a battery (200) in a charge-receiving mode for keeping the battery in a charged state, in which the battery (200) alternates cyclically between a resting phase (R) and a refreshing phase (A),
in which the battery (200), in the resting phase (R), discharges from an upper threshold voltage (U_{OG}) to a lower threshold voltage (U_{UG}) which is lower than the upper threshold voltage but is preferably higher than the rated voltage of the battery; and
in which the battery (200), in the refreshing phase (A), is charged again from the lower to the upper threshold voltage via a charge transformer (120) of the charger (100);
characterized in that at least individual components, in particular the charge transformer (120) of the charger (100), are switched off from the line voltage (U_{N}) during the resting phase (R)

2. The method according to claim 1, characterized in that in the charge-receiving mode, the alternation from the resting phase (R) to the refreshing phase (A) takes place whenever the battery voltage (U_{B}) has reached or undershot the lower threshold voltage (U_{UG}).

3. The method according to claim 1, characterized in that the battery (200) is charged with a predefined constant charging current (I_{L}) during the refreshing phase (A).

4. The method according to claim 1, characterized in that in the charge-receiving mode, the alternation from the refreshing phase (A) to the resting phase (R) is effected whenever the battery (200) has been charged to the upper threshold voltage or above it.

5. The method according to claim 1, characterized in that the charge-receiving mode is preceded by a charging mode (A_{L}), in which the battery (200), in a first phase, is charged preferably with a constant current to the upper threshold voltage (U_{OG}) and, in a second phase, is supplied with a constant charging voltage.

6. The method according to claim 5, characterized in that an alternation from the second phase of the charging mode to the charge-receiving mode, in particular to the resting phase (R), takes place when the upper threshold voltage (U_{OG}) has been maintained with the aid of the constant charging voltage, and simultaneously the charging current has dropped to a predetermined value that is less than the value of the constant current in the first phase.

7. A computer program having a program code for a battery charger, characterized in that the program code is embodied for performing the method according to claim 1.

8. A data medium having a computer program according to claim 7.

9. A charger (100) for charging a battery (200) from a line voltage (U_{N}), including:
a charge transformer (120) for transforming the primary line voltage (U_{N}) into a secondary voltage;
a rectifier (130), which is connected downstream of the charge transformer (120) on its secondary side, for furnishing a charging voltage (U_{B}) for the battery from the secondary voltage; and
a control unit (150) for triggering the rectifier (130) via a control signal (S1) in response to the charging voltage (U_{B}), in particular in such a way that the battery (200), after its charging phase, is kept in its charged state in that the battery (200) alternates cyclically between a resting phase (R), in which the battery discharges from an upper threshold voltage (U_{OG}) to a lower threshold voltage (U_{UG}) which is lower than the upper threshold voltage but preferably greater than the line voltage of the battery, and a refreshing phase (A), in which the battery (200) is charged again from the lower to the upper threshold voltage via the charge transformer (120) of the charger (100);
characterized by a first comparator (160) for generating a first comparison signal (V1), when the battery voltage (U_{B}) at the end of the refreshing phase has reached or exceeded the upper threshold voltage (U_{OG}); and
a switching device (110) for switching off at least the charge transformer (120), during the resting phase (R), from the line voltage (U_{N}) in response to a switching signal (S2), which represents the first comparison signal (V1).

10. The charger (100) according to claim 9, characterized by a second comparator (170) for generating a second comparison signal (V2), when the battery voltage (U_{B}) at the end of the resting phase (R) has reached or undershot the lower threshold voltage (U_{UG}).

11. The charger (100) according to claim 10, characterized by an OR logic module (180) for furnishing the switching signal (S2) for the switching device (110) as an OR linkage from the first and the second comparison signals (V1, V2).

12. The charger according to claim 11, characterized in that the two comparison signals (V1, V2) are synchronized with one another in such a way that upon generation of the first comparison signal (V1), the second comparison signal (V2) is also converted to a state such that the switching signal (S2) at the output of the OR logic module (180) assumes a state which switches off the switching device (110).

13. The charger (100) according to claim 9, characterized by a supply transformer (140) for supplying the control unit (150), on its secondary side, with a supply voltage.

14. The charger according to claim 13, characterized in that the supply transformer (140) is connected downstream of the switching device (110) and with its primary side is connected parallel to the charge transformer (120).

15. The charger according to claim 13, characterized in that the supply transformer (140) is connected upstream of the switching device (110) and is coupled with its primary side to the line voltage (U_{N}).

16. The charger (100) according to claim 9, characterized in that the control unit, the first and second comparators (160, 170), and/or the OR logic module (180) are realized as an integrated circuit, preferably as a microcontroller or microprocessor with a suitable computer program.

17. The charger (100) according to claim 9, characterized in that the comparators (160, 170) are embodied by analog hardware.

18. The charger (100) according to claim 9, characterized in that the switching device (110) is embodied as an opto-triac.
